(19) United States
(12) Patent Application Publication
(10) Pub. No.: US 2012/0176317 A1
(43) Pub. Date: Jul. 12, 2012

(54) Wireless Mouse Charge Device and Wireless Mouse Charge System

(75) Inventor: Lei JIN, Beijing (CN)

(73) Assignee: BEIJING SIGMACHIP CO.,LTD., Beijing (CN)

(21) Appl. No.: 13/072,802

(22) Filed: Mar. 28, 2011

(30) Foreign Application Priority Data
Jan. 6, 2011 (CN) 201120008015.4

(51) Int. Cl. G06F 3/033

(52) U.S. Cl. 345/163

(57) ABSTRACT

A wireless mouse charge device, disposed within a notebook computer, charges the wireless mouse by the electromagnetic induction effect, in which the wireless mouse charge device includes the shoot area and the electromagnetic induction device. The shoot area is a part of the case of the notebook computer, and the electromagnetic induction device is set within the notebook computer and disposed under the shoot area, in which the electromagnetic induction device generates the induced magnetic field that charges the wireless mouse.

### RELATED APPLICATIONS

This application claims priority to Chinese Application Serial Number 201120008015.4, filed Jan. 06, 2011, which is herein incorporated by reference.

### BACKGROUND

1. Field of Invention

The present invention relates to a charge device. More particularly, the present invention relates to the charge device for charging the mouse.

2. Description of Related Art

Generally speaking, the current computer mice can be broadly classified into two types, the mechanical computer mice and the optical computer mice. The mechanical type computer mouse usually includes a trackball, and the code-axis or the grating device converts the trace of the trackball to digital signal which is transferred to the computer through the transmission line, such that the mouse cursor on the computer screen moves accordingly.

The optical type mouse emits the light source which irradiates the mouse pad or desk through a small hole on the bottom of the computer mouse; when the light is reflected to the light sensor inside the computer mouse, the varying image of the mouse pad or the desk is captured. The computer mouse's movement obtained through comparing and calculating is then transferred to the computer through the transmission line for further computing and operation.

Both of the mechanical type mouse and the optical type mouse are tied with a transmission line which is necessary for passing the operation data or movement data of those computer mice from the computer mice to the computer, and the transmission line needs to move with the computer mouse when the computer mouse is moved. However, the transmission line might be stumbled when the computer mouse moves, which blocks the moving of the computer mouse.

In order to solve the problem, the information industry tries to develop a different kind of computer mouse which is more convenient for use. The in industry has gradually developed the wireless mouse which doesn't need to employ the transmission line. The transmitter module, which transmits the movement and the click of the wireless mouse to the computer, is installed inside the wireless mouse. For example, the movement and the click of the wireless mouse are passed to the computer by wireless communication system such as the Bluetooth.

However, the wireless mouse either requires batteries to provide power, or requires additional external charge equipment to charge the wireless mouse, which is neither economic nor convenient. Therefore, there is a need for a new wireless mouse which requires no external charge device.

### SUMMARY

According to one embodiment of the present invention, the wireless mouse charge device, disposed within a notebook computer, charges a wireless mouse with the electromagnetic induction effect, in which the wireless mouse charge device includes a shoot area and a computer side electromagnetic induction device. The shoot area is a part of a covering case of the notebook computer. The computer side electromagnetic induction device is set within the notebook computer and is disposed under the shoot area, in which the computer side electromagnetic induction device generates an induced magnetic field for charging the wireless mouse.

According to another embodiment of the present invention, a wireless mouse charge system charges with electromagnetic induction effect, in which the wireless mouse charge system includes a wireless mouse that has a covering surface and a receive area. The receive area, a part of the covering surface, receives the induced magnetic field. The mouse side electromagnetic induction device is disposed within the wireless mouse and faces the receive area, in which the mouse side electromagnetic induction device converts the received induced magnetic field to supply the wireless mouse.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A shows one portion diagram of the wireless mouse charge system according to one embodiment of the present invention;

FIG. 1B shows another portion diagram of the wireless mouse charge system according to another embodiment of the present invention;

FIG. 1C shows the other portion diagram of the wireless mouse charge system according to another embodiment of the present invention;

FIG. 2A shows the block diagram of the computer side electromagnetic induction device according to another embodiment of the present invention;

FIG. 2B shows the circuit diagram of the shoot circuit according to another embodiment of the present invention; and

FIG. 3 shows the block diagram of the mouse side electromagnetic induction device according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The wireless mouse charge device and the wireless mouse charge system of the following embodiments can charge the wireless mouse without the external charging device, which saves the space, eliminates the battery cost and the battery replacing procedures. In addition, the wireless mouse can move freely without being stumbled by the transmission line, which facilitates the use of the wireless mouse.

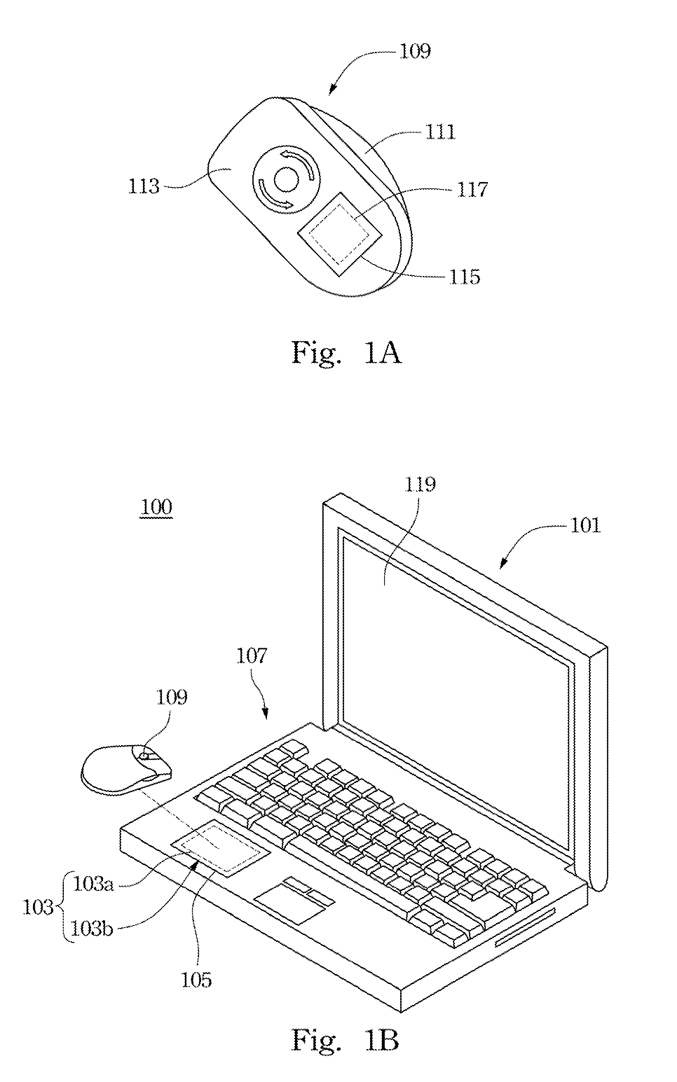

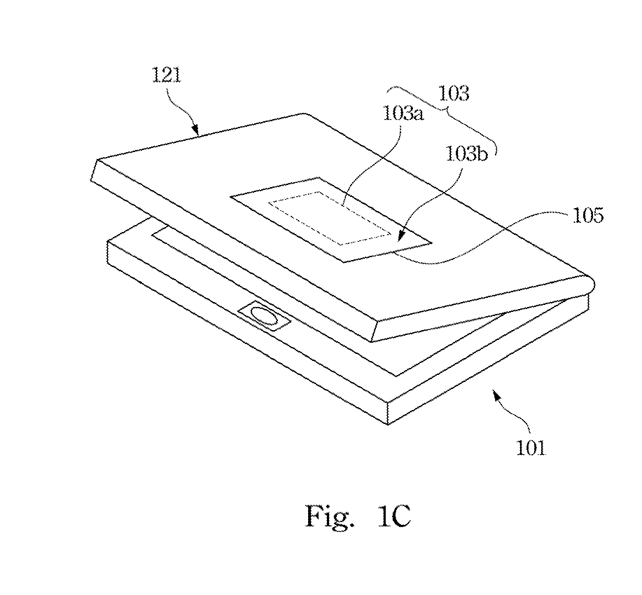

Please simultaneously refer to FIG. 1A, FIG. 1B, and FIG. 1C which show different portion diagrams of the wireless mouse charge system according to the embodiments of the present invention. The wireless mouse charge system 100 charges the wireless mouse 109 with the electromagnetic induction effect, in which the wireless mouse charge system 100 includes the wireless mouse 109 and the wireless mouse charge device 103.

The wireless mouse 109 can process the data with the optical technique. For example, the wireless mouse 109 can encode the optical signal which contains the input data and transmit the encoded signal through the radio wave;

the notebook computer 101 then receives and decodes the encoded signal carried by the radio wave, transforms the decoded signal into specific type required by the notebook computer 101, and the notebook computer 101 can further process the data in that specific type.

The wireless mouse 109 includes the covering surface 111 and the mouse side electromagnetic induction device 117 disposed under the covering surface 111. The receive area 115 is a part of the covering surface 111, and the mouse side electromagnetic induction device 117, disposed within the wireless mouse 109 and facing the receive area 115, converts the received induced magnetic field for charging the wireless mouse 109. In more detail, the receive area 115 is disposed on the bottom 113 of the covering surface 111; the wireless mouse charge device 103 can charge the wireless mouse 109 once the receive area 115 on the bottom 113 faces the shoot area 103b of the wireless mouse charge device 103, and the battery or the external charge device is no longer required, which facilitates the use of the wireless mouse 109.

On another aspect, the wireless mouse charge device 103 is disposed within the notebook computer 101 and charges the wireless mouse 109 with the electromagnetic induction effect, in which the wireless mouse charge device 103 includes the shoot area 103b and the computer side electromagnetic induction device 103a. The shoot area 103b is a part of the covering case of the notebook computer 101 and has a closed boundary 105 within which the wireless mouse 109 can be disposed to be charged; that is, when the wireless mouse 109 faces the area surrounded by the closed boundary 105, the wireless mouse 109 is charged effectively even if it doesn't contact with the shoot area 103b.

As shown in FIG. 1B, the shoot area 103b is a part of the keyboard area of the notebook computer 101, and the wireless mouse 109 is attached to the shoot area 103b located near the keyboard through the magnet or other attach element; the shoot area 103b can also be a part of the covering case 121 as shown in FIG. 1C, while the wireless mouse 109 is attached to the shoot area 103b on the covering case 121 through the velcro or other attach element.

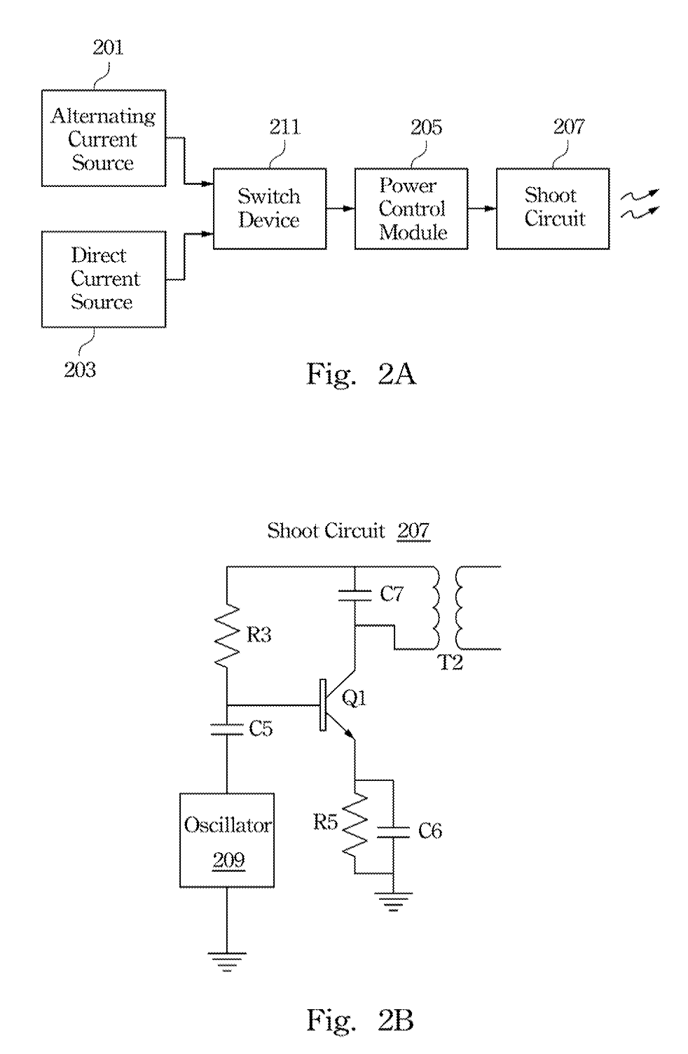

FIG. 2A shows the block diagram of the wireless mouse charge device according to one embodiment of the present invention. The computer side electromagnetic induction device includes the alternating current source 201, the direct current source 203, the switch device 211, the power control module 205, and the shoot circuit 207. The switch device 211 switches the alternating current source 201 as well as the direct current source 203 and passes one of the current sources to the power control module 205. The power control module 205 converts the alternating current source 201 or the direct current source 203 into the power source accepted by the shoot circuit 207 to supply the shoot circuit 207, such that the shoot circuit 207 can obtain the required coil current and generate the induced magnetic field.

In more detail, the input terminal of the computer side electromagnetic induction device can employ the bridge-rectifier circuit to convert the alternating current source 201 into the direct current source employed by the power control module 205; the input terminal of the computer side electromagnetic induction device can also directly provide the 24V direct current source 203 to the power control module 205. After passing the power control module 205, the direct current source 203 is converted into the coil current of high frequency alternating type.

The coil current of high frequency alternating type is provided to the inductor coil within the shoot circuit 207, and the electromagnetic induction effect converts the coil current on the inductor coil into the induced magnetic field and emits the induced magnetic field to charge the wireless mouse 109. If the electromagnetic induction effect generated by the induced magnetic field is not sufficient enough, the user can connect with the external power supply through the USB transmission interface to provide the power to the wireless mouse 109, and the user can continue to use the wireless mouse 109 immediately without stopping. In other words, the user can continue to finish the work without stopping due to the insufficient power supply.

FIG. 2B shows the circuit diagram of the shoot circuit according to one embodiment of the present invention. The shoot circuit 207 emits the induced magnetic field to charge the wireless mouse, in which the shoot circuit 207 includes the oscillator 209, the capacitor C5, the capacitor C6, the capacitor C7, the resistor R3, the resistor R5, the transistor Q1, and the air core coil T2. The diameters of the air core coils T2 are 0.5 mm and 7 cm, and the inductance is 47 uF. If the carrier frequency is 2 MHZ, the match capacitance of the capacitor C7 is about 140 pF according to the parallel resonant formula. The required frequency of the oscillator is 2 MHZ, which generates the carrier having frequency close to the resonant frequency.

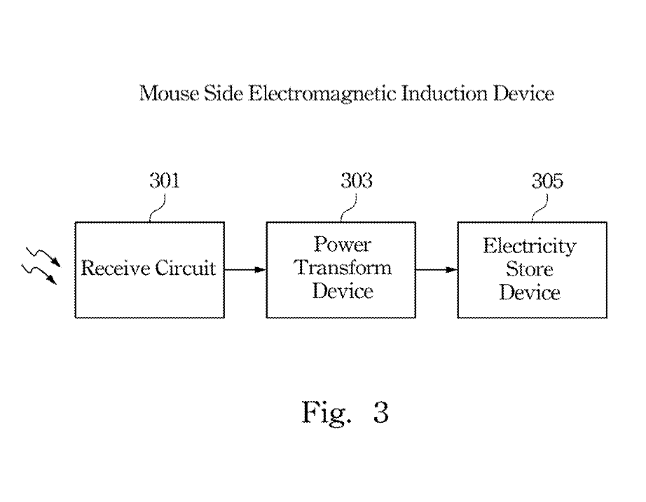

FIG. 3 shows the block diagram of the mouse side electromagnetic induction device according to one embodiment of the present invention. The mouse side electromagnetic induction device includes the receive circuit 301, the power transform device 303, and the electricity store device 305. The receive circuit 301 receives and converts the induced magnetic field from the wireless mouse charge device into the induced current; the power transform device 303 converts the induced current generated by the receive circuit 301 into the supply current to supply the wireless mouse. The electricity store device 305 receives and stores the supply current generated by the power transform device 303.

The wireless mouse charge device and the wireless mouse charge system of the above embodiments can charge the wireless mouse without the external charging device, which saves the space, eliminates the cost and the battery replacing procedures, and is both convenient as well as environmentally; the power of the wireless mouse will not be broken off just because the user doesn't replace the battery on time, and the backup batteries is no longer required. In addition, the wireless mouse can move freely without being stumbled by the transmission line, which facilitates the use of the wireless mouse.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A wireless mouse charge device, disposed within a notebook computer, charges a wireless mouse with electromagnetic induction effect, wherein the wireless mouse charge device comprises:
a shoot area being a part of a covering case of .the notebook computer; and
a computer side electromagnetic induction device set within the notebook computer and disposed under the shoot area, in which the computer side electromagnetic induction device generates an induced magnetic field for charging the wireless mouse.

2. The wireless mouse charge device as claimed in claim 1, wherein the computer side electromagnetic induction device comprises a shoot circuit for converting a coil current into the induced magnetic field.

3. The wireless mouse charge device as claimed in claim 2, wherein the computer side electromagnetic induction device further comprises a power control module which converts an alternating current source or a direct current source to supply the shoot circuit that generates the induced magnetic field.

4. The wireless mouse charge device as claimed in claim 1, wherein the shoot area is part of the covering case near a keyboard, and the wireless mouse faces the shoot area to get charged.

5. The wireless mouse charge device as claimed in claim 1, wherein the shoot area has a closed boundary within which the wireless mouse is disposed to be charged.

6. A wireless mouse charge system, charging with electromagnetic induction effect, the wireless mouse charge system comprising:
a wireless mouse comprising:
a covering surface;
a receive area, being a Oft of the covering surface, for receiving induced magnetic field; and
a mouse side electromagnetic induction device disposed within the wireless mouse and facing the receive area, wherein the mouse side electromagnetic induction device converts the received induced magnetic field for supplying the wireless mouse.

7. The wireless mouse charge system as claimed in claim 6, further comprising a wireless mouse charge device disposed within a notebook computer and charging the wireless mouse with the electromagnetic induction effect, wherein the wireless mouse charge device comprises:
a shoot area being a part of a covering case of the notebook computer; and
a computer side electromagnetic induction device set within the notebook computer and disposed under the shoot area, in which the computer side electromagnetic induction device generates the induced magnetic field for charging the wireless mouse.

8. The wireless mouse charge system as claimed in claim 7, wherein the receive area of the wireless mouse is disposed on a bottom of the covering surface, and the wireless mouse charge device charges the wireless mouse when the receive area of the wireless mouse faces the shoot area of the wireless mouse charge device.

9. The wireless mouse charge system as claimed in claim 6, wherein the mouse side electromagnetic induction device further comprises:
a receive circuit for converting the received induced magnetic field into induced current; and
a power transform device for converting the induced current generated by the receive circuit into a supply current to supply the wireless mouse.

10. The wireless mouse charge system as claimed in claim 9, wherein the mouse side electromagnetic induction device further comprises an electricity store device for receiving and storing the supply current generated by the power transform device.
